(19) United States
(12) Patent Application Publication
(10) Pub. No.: US 2008/0292836 A1
(43) Pub. Date: Nov. 27, 2008

(54) WRAP-AROUND PLACE MAT

(75) Inventor: Admir James MESALIC, Las Vegas, NV (US)

Correspondence Address: HUSCH BLACKWELL SANDERS LLP, 720 OLIVE STREET, SUITE 2400, ST. LOUIS, MO, 63101, US

(73) Assignee: CLASSY KID, INC., Las Vegas, NV (US)

(21) Appl. No.: 12/174,347

(22) Filed: Jul. 16, 2008

Related U.S. Application Data
(63) Continuation-in-part of application No. 11/308,038, filed on Mar. 3, 2006.

(51) Int. Cl. B32B 3/06

(52) U.S. Cl. 428/99

(57) ABSTRACT

A wrap-around place mat adaptable for use on a table-like surface for covering a portion of the eating or play surface in front of a child, the place mat including a first table top portion, a second wrap-around securement portion adaptable for wrapping around an edge surface associated with the table-like surface and being positionable on at least a portion of the side portion thereof, and an attachment mechanism associated with at least the second portion for securing the place mat to the table-like surface and at least its associated side portion. In some embodiments, the wrap-around portion is likewise attachable to at least a portion of the underneath portion of the table-like surface and may include a pocket member. The present place mat may likewise include indicia or other ornamentation associated with the table top portion for occupying the attention of a child, and the present place mat can likewise be made of a material which includes an inorganic mineral powder such as calcium carbonate, and can be made to be at least water resistant and preferably waterproof.

### CROSS REFERENCE TO RELATED APPLICATION

This application is a Continuation-In-Part application of application Ser. No. 11/308,038 entitled Wrap-Around Place Mat filed on Mar. 3, 2006 and published as U.S. Publication 2007/0207279 on Sep. 6, 2007. The entire disclosure of this application is incorporated herein by reference.

### BACKGROUND OF THE INVENTION

The present invention relates to place mats such as those used to cover table tops or other surfaces where children eat or otherwise play and, more particularly, to a wrap-around place mat which is adhesively secured to the table surface and includes a portion or member which wraps around the edge surface of the table.

Small children tend to create a mess when eating and/or playing. They are always spilling their drink or dropping and/or playing with their food, writing or coloring on the table top, and perform other similar acts which create a mess and/or can damage the surface of the table or other surface associated with the child's particular activity. After eating or otherwise playing, the parent is left with the chore of cleaning up the mess. If the table top or other surface is expensive, damage may occur. Therefore, most parents prefer to use a place mat for positioning on the table top in front of the child on such occasions. However, children will undoubtedly move, displace, or remove the place mat from its proper position or use it as a toy, causing the table top to be exposed. Therefore, it is preferred that the place mat include some means for removably receiving or attaching the place mat to the table surface.

Self-adhesive place mats are known in the prior art, but these prior art devices are easily removed or displaced by a child as he or she can easily slide his or her fingers under the front or sides of the place mat, allowing for a better grip, thereby facilitating easy displacement or removal of the place mat from its secured position. Therefore, there is also a need for a self-adhesive place mat that is difficult for a child to remove from its secured position on the surface to which it is attached.

Still further, children are especially susceptible to exposure from bacteria and other germs, possibly causing illness. As any parent knows, a young child will attempt to chew on anything within their reach. When dining at a restaurant or other public place, there is a danger that the child will be exposed to germs by chewing on the table top in front of them, if the child can reach the edge of the table, or from touching and/or running their hands along the side edge and the underside portion of the table. Since restaurant personnel do not typically clean the underside portion of the table, this portion of the table may be unsanitary. Therefore, there is also a need for some means to cover the entire table surface in front of a child, including the edge of the table, the side portion of the table, and the underside portion of the table directly in front of the child.

It is also recognized that if a child's attention is occupied, they will be better behaved, allowing the parent to enjoy their meal or other activity with less supervision of the child. Therefore, place mats with attention-grabbing designs or games incorporated thereon are generally preferred by parents.

Although a wide variety of place mats are known in the prior art, and although some of these place mats include various adhesive devices for attaching to the top surface of a particular table, no known prior art place mat covers the entire surface of the table in front of the child, including the side edge and side portion of the table, and including a portion of the underside portion of the table. Therefore, the known prior art devices do not protect a child from being exposed to the germs associated with the edge, side and underneath portions of the table and the prior art devices are not positioned on the table surface in such a manner which makes it more difficult for a child to slide his or her fingers underneath the place mat in order to remove it from the table surface.

Accordingly, the present invention is directed to a place mat which overcomes one or more of the problems set forth herein.

### SUMMARY OF THE INVENTION

The present invention overcomes many of the shortcomings and limitations discussed above and teaches the construction, operation and use of several embodiments of a wrap-around place mat adaptable for use in covering not only that portion of an eating or play surface in front of a child, but also wraps around the table edge and, in one embodiment, covers the side portion of the table and, in the another embodiment, covers the underside portion of the table, and is removably secured thereto. In one aspect of the present invention, the present wrap-around place mat includes a first portion or table top member, preferably with indicia or other ornamentation thereon to occupy a child, a second portion or wrap-around securement member, and attachment means associated respectively therewith for removably attaching the place mat to various surfaces of the table or other support surface. The wrap-around securement portion overlaps and covers at least the edge and at least a portion of the side portion of the table and, in another aspect of the present invention, overlaps and covers the underside portion of the table as well. The attachment means removably fixes the place mat at the proper location in front of the child and helps to prevent movement and/or removal of the place mat by the child.

In another aspect of the present invention, a catch pocket may be associated with the wrap-around securement portion of the present place mat for catching crumbs and other debris before they fall to the floor.

In another aspect of the present invention, the flexible sheet of material forming the place mat is made of a composition that includes at least one inorganic mineral powder and a thermoplastic polymer wherein the sheet material is preferably environmentally degradable and capable of being written or marked on directly with a crayon or other writing or marking instrument. The place mat is also preferably at least water resistant.

### DESCRIPTION OF THE DRAWINGS

For a better understanding of the present invention, reference may be made to the accompanying drawings.

FIG. 1 is a top plan view of one embodiment of the present wrap-around place mat constructed in accordance with the teachings of the present invention.

FIG. 2 is a bottom plan view of the wrap-around place mat of FIG. 1.

FIG. 3 is a perspective view of the wrap-around place mat of FIG. 1 showing the wrap-around securement portion in a first secured position.

FIG. 4 is a perspective view of the wrap-around place mat of FIG. 1 showing the wrap-around securement portion in a second secured position.

FIG. 5 is a perspective view of another embodiment of the present wrap-around place mat constructed in accordance with the teachings of the present invention incorporating the use of a pocket member.

FIG. 6 is a perspective view of still another embodiment of the present wrap-around place mat constructed in accordance with the teachings of the present invention.

### DETAILED DESCRIPTION

Referring to the drawings more particularly by reference numbers wherein like numbers refer to like parts, the number 1 in FIGS. 1-4 identifies a wrap-around place mat constructed according to the teachings of one embodiment of the present invention. The place mat 1 includes a table top portion 2, a wrap-around securement portion 4, at least one adhesive strip 6, and indicia or other ornamentation 8 which functions to entertain and maintain a child's attention. The table top portion 2 may be sized similar to a conventional prior art place mat and covers that portion of a typical table 10 directly in front of where a child would be seated for eating or other activities. Although the preferred use of the present invention is on a table, use of the place mat 1 on any surface suitable for a child's activities is within the scope of the present invention.

The table top portion 2 is preferably large enough to cover the entire area around and in front of a child so as to prevent the table top from being exposed to food, drink, or other mess or damage, but not so large as to be unduly burdensome to use on a small table top area. In one embodiment, the table top portion 2 is fabricated out of a plastic material, as this material is relatively inexpensive, flexible, durable, repels liquids, and will not tear or rip easily. However, any suitable material will suffice, including a paper-based material. Although the table top portion 2 is illustrated as being substantially rectangular in shape as shown in FIGS. 1-4, it is recognized and anticipated that the table top portion 2 may take on a wide variety of different shapes including attention-grabbing shapes such as an animal shape.

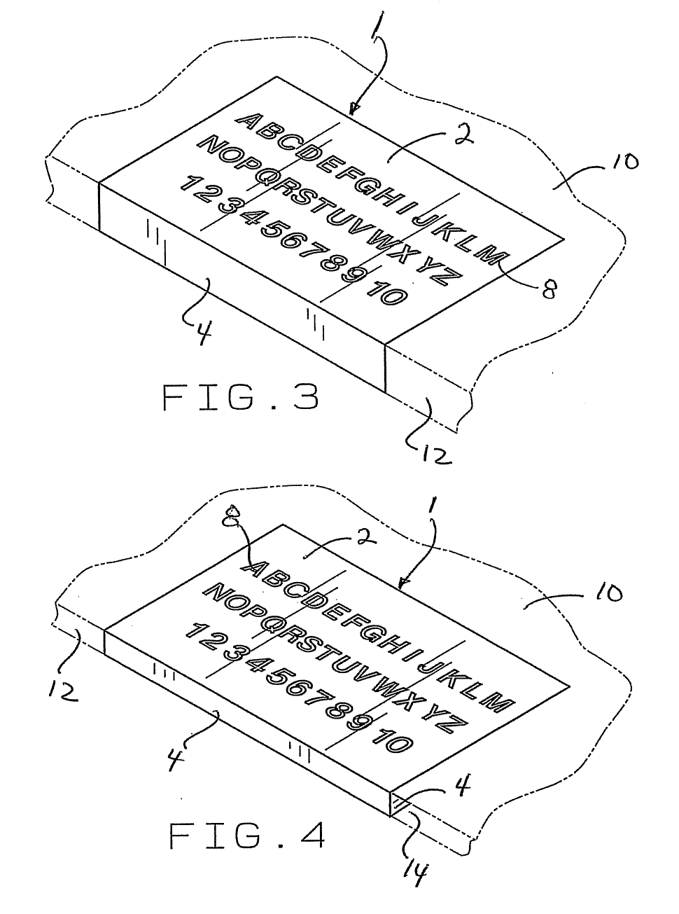

A wrap-around securement portion 4 is preferably integrally formed with the table top portion 2 and is designed to wrap around the edge of the table top 10 and conform to either the side portion 12 of the table 10 as illustrated in FIG. 3, or to both the side portion 12 and the underside portion 14 of the table 10 as illustrated in FIG. 4. The wrap-around securement portion 4 is flexible and easily bends and is preferably constructed of a flexible material, such as a plastic material, so that it will conform to various table edge shapes and sizes. For example, some tables are very thin, with a side edge portion of only an inch or less in height, while others are very thick, with side edge portions several inches or more in height, while still other tables have various designs incorporated into the table edges and side portions. It is therefore important that the wrap-around securement portion 4 be flexible so as to conform to all these divergent table side edge shapes and sizes. The wrap-around securement portion 4 is sized so as to cover even large table edges, and side portions, while in some embodiments, having enough material to cover a portion of the underside portion of the table. However, the wrap-around securement portion 4 should not be so large as to be burdensome to secure to the edge, side and the underside portions of the table.

As shown in FIGS. 3 and 4, the wrap-around securement edge portion 4 covers at least the table side portion 12 as shown in FIG. 3 and preferably also the underneath portion 14 of the table as shown in FIG. 4. This serves two purposes. First, it prevents a child from sliding his or her fingers underneath the place mat thereby preventing a child from getting a better grip on the place mat and encouraging and facilitating a more easy removal of the place mat from the table surface. Second, the side portion 12 and underneath portion 14 of the table 10 may be unsanitary, particularly at a restaurant, since these portions are exposed to many people. Therefore, the present invention provides a wrap-around securement portion 4 to cover the unsanitary portions of the table.

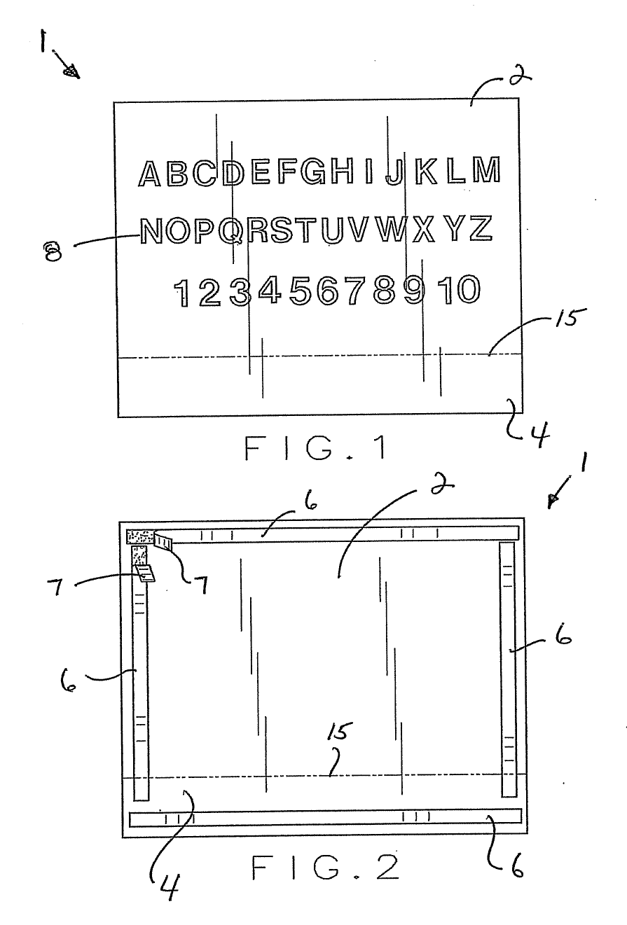

The wrap-around place mat 1 also includes attachment means associated with the bottom portion thereof. Preferably, the attachment means includes at least one adhesive strip 6 extending around the periphery of the back portion of the place mat 1 as illustrated in FIG. 2. Because of the adhesive strip 6, the wrap-around place mat 1 is removably secured in its place so that a child may not easily move or otherwise displace or remove the place mat 1. This adhesive strip 6 may be one contiguous strip extending around the periphery or any plurality of adhesive strips 6, such as one for each side of the wrap-around place mat 1 as illustrated in FIG. 2. An adhesive strip 6 is also included on the wrap-around securement portion 4 so that the user may secure the wrap-around securement portion 4 to the side portion 12 or underside portion 14 of the table 10. The adhesive strip 6 is preferably positioned near the periphery of the wrap-around place mat 1 so that a child cannot easily slide his or her fingers underneath the mat. The adhesive strip 6 preferably includes a removable adhesive cover 7 which can be removed just before securing the wrap-around place mat 1 to a particular table 10. The removable adhesive cover 7 prevents the place mat 1 from adhering to unwanted surfaces when not in use. Attachment means other than an adhesive strip 6 are also contemplated and within the scope of the present invention. For example, the periphery or the entire underside portion of the place mat 1 may be coated with an adhesive substance. Still further, the attachment means may be separate from the place mat 1, but used to secure the place mat 1 in proper position on the table 10 when in use. For example, a tape-like product may be positioned around the periphery of the place mat at the time of use. The type and positioning of the attachment means is subject to change depending upon the types of materials being used, the size and shape of the respective portions or members 2 and 4, and costs.

The place mat 1 may also include indicia or other ornamentation 8 designed to occupy a child's attention. If a child is not occupied, they may be more likely to cry, play with their food, or otherwise misbehave. Therefore, the wrap-around place mat 1 may include indicia or ornamentation 8 to occupy the child. The indicia or ornamentation 8 may include games, stories, the alphabet, numbers, entertaining pictures, coloring figures or any other ornamentation designed to garner the child's attention. The ornamentation should not be mere decoration, but should be designed specifically to entertain small children.

It is also recognized and anticipated that the wrap-around place mat 1 of the present invention can be fabricated into a two piece member wherein the table top portion 2 and the wrap around securement portion 4 are separate attachable members. In this embodiment, the wrap around securement member 4 would be either fixedly or removably attached to the table top member 2 using a wide variety of conventional attachment means. For example, the wrap around securement member 4 could be fixedly attached to the table top member 2 by using a wide variety of different types of adhesive means, by heat sealing the members together, or by stitching. In similar fashion, the wrap around securement member 4 could be removably attached to the table top member 2 by using a suitable adhesive means, by using cooperatively engageable means such as VELCRO loop fasteners, snap fasteners, buttons and the like. In this particular configuration, the members 2 and 4 could be made out of different types of materials, although the wrap around securement member needs to be somewhat flexible so that it can wrap around the edge of table top surface for engagement to either the side portion 12 of a particular table 10, or to the underside portion 14 of a particular table 10. Like the place mat 1, this embodiment would likewise include appropriate attachment means such as one or more adhesive strips 6 associated with the back portion of the place mat as previously explained and as illustrated in FIG. 2. It is also recognized that, in this particular embodiment, the wrap around securement member 4 could be fashioned in a variety of different sizes and shapes to accommodate different types and different styles of table edge surfaces and side portions. It is also anticipated that a plurality or set of wrap around securement members 4 could be provided with a particular table top member 2 so that the user can selectively attach the appropriate size member 4 to the member 2 to accommodate the particular table at hand. Other variations associated with the size and configuration of the members 2 and 4 as well as a wide variety of other permanent and removably attachable means are contemplated, and may be used with the present invention.

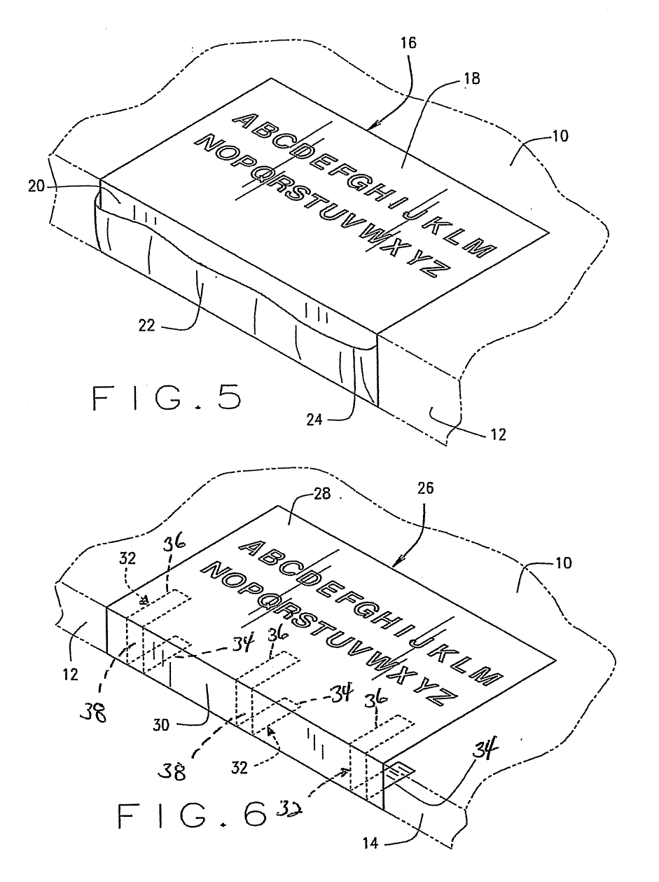

FIG. 5 illustrates another embodiment 16 of a wrap-around place mat constructed according to the teachings of the present invention. The place mat 16 likewise includes a table top portion 18, a wrap-around securement portion 20, appropriate attachment means such as one or more adhesive strips 6 (not shown), and a pocket member 22 associated with the wrap-around securement portion 20. The pocket member 22 is designed to catch crumbs or other debris that may be deflected or maneuvered off of the table top portion 18 of the place mat 16 by a child and which would otherwise end up on the floor surface below. Instead, the pocket member 22 would catch these crumbs or other debris and facilitate clean up of the area following the child's particular activity. The pocket member 22 can be formed integral with the wrap-around portion 20; it can be formed as a flap member associated with the terminal end portion of the wrap-around portion 20 which can be folded up and secured to the side edges thereof via any suitable attachment means including cooperatively engageable means such as VELCRO type fasteners; it can be formed as a molded member in conjunction with the wrap-around portion 20; or, in the case where the wrap-around portion 20 is formed of a relatively flexible material, the pocket member 22 could be formed as a pocket on the back side of the wrap-around portion 20 and can be reverse folded to the outside portion of the wrap-around portion 20 such that the upper edge surface 24 of the pocket member 22 is spaced from the wrap-around portion 20 thereby maintaining the pocket 22 in an open configuration for catching crumbs and other debris. When made of a relatively flexible material, the pocket member 22 is also flexible and collapsible so as to lie in the same plane as the wrap-around portion 20 in its stored condition. In this regard, the entire place mat 16 can be folded and stored in a relatively small space for carrying in a purse, bag or other item.

FIG. 6 illustrates still another embodiment 26 of a wrap-around place mat constructed according to the teachings of the present invention. The place mat 26 likewise includes a table top portion 28, a wrap-around portion 30 and a plurality of clip members or attachment members 32 which are integrally formed with or fixedly attached to the place mat 26 for attaching the wrap-around portion 30 to a particular table such as the table 10. One embodiment of the clip members 32 is illustrated in FIG. 6 and includes a substantially U-shaped member having opposed leg portions 34 and 36 and an intermediate portion 38 extending therebetween. Leg portion 34 is exposed whereas leg portion 36 and intermediate portion 38 are attached to, formed with or otherwise embedded in the wrap-around portion 30 and part of the table top portion 28 as illustrated in FIG. 6. The resiliency of the leg portion 34 relative to the leg portion 36 provides sufficient holding force to maintain the place mat 26 attached to the table 10.

Still further, in the embodiment of FIG. 6, the entire place mat 26 could be formed of a molded plastic material and could be substantially J-shaped in configuration wherein at least the exposed leg portions 34 of the clip members 32 are somewhat resilient so as to sufficiently attach and hold the wrap-around portion 30 to the particular side portion 12 and underside portion 14 of the table 10. Since this particular embodiment may be used as a reusable place mat, the back surface of the table top portion 28 may be formed of a non-slip rubber backing material. It is also recognized and anticipated that the back surface of the table top portion 28 may likewise include removable attachment means for fixedly securing the table top portion 28 to a particular table 10 during use. Such removable attachment means may include suction cups, pressure sensitive adhesives, and other suitable means. It is also anticipated that any plurality of clip members 32 may be associated with the place mat 26 including having a single clip member 32 extending the full length of the wrap-around portion 30, or just a pair of clip members 32 positioned respectively at the opposite end portions of the wrap-around portion 30 adjacent the side edges thereof. Other clip arrangements and configurations are likewise envisioned and anticipated.

It is also recognized and anticipated that the place mat 26 can be formed out of any suitable material including a flexible material for both the table top portion 28 and the wrap-around portion 30. Still further, the clip members 32, although preferably integrally formed or permanently affixed to the place mat 26, can likewise be provided as separate members in kit form for suitably attaching the wrap-around portion 30 of the place mat 26 to a particular table 10.

The present place mats 1, 16 and 26 are specifically designed for attachment to and wrap-around portions of a supporting member such as table 10. It is contemplated that the present place mats can be used on any structure having a surface to provide protection to the surface during a child's play. This could include use on countertops, coffee tables, various furniture surfaces, a desk top, an airline table tray and other similar surfaces. It is also contemplated that the present place mats could be fabricated as a one-piece, unitary member as disclosed in FIGS. 1-6, or as component members as described above. It is also recognized that the present place mats could be packaged in a wide variety of different applications including a plurality of place mats similar in size and shape; a plurality of differently sized place mats to accommodate different table top surfaces; and, when used as separate members such as separate members 2 and 4, in kit form where a plurality of differently sized and shaped wrap-around securement members 4 could be provided with a standard size table top member 2. It is also recognized that when the present members such as the members 2 and 4 are provided as separate, individual components, a plurality of differently sized and shaped table top members 2 can likewise be provided in kit form in association with a plurality of differently sized and shaped wrap-around securement members 4. Other variations, uses and applications of the present place mats are likewise envisioned and contemplated.

Still further, it is also recognized that the place mats 1, 16 and 26, when utilized as a unitary, one-piece mat may include a fold line or other marking or indicia 15 on at least the front surface thereof for indicating to a user the approximate location for folding or wrapping around the place mats 1, 16 and/or 26 about the edge portion of the table top or other surface to which the place mat is being positioned, the fold line or other marking 15 separating the table top portion from the wrap-around portion. It is also recognized and anticipated that other fold lines and/or indicia may be utilized on the front surface of the present place mats similar to the fold line 15 for indicating where to fold the present place mats with respect to a wide variety of differently shaped tables or other supporting surfaces. For example, if the present place mat 1 is to be utilized on a round or circular table top, the fold line 15 may be oriented in an arcuate shape to accommodate a circular surface. In this situation, the table top portion 2 may also include fold lines (not shown) such as pie-shaped fold lines for indicating where and how to fold over a portion of the table top portion 2 to conform to the circular shape of the table top. Other orientations and configurations of the fold line 15 can be utilized depending upon the particular shape of the supporting surface to which the particular place mat will be positioned and attached. Fold lines or other markings and/or indicia similar to the fold line 15 can likewise be utilized in association with the two-piece embodiment of the present place mats as well.

Still further, in another embodiment of the present invention, the flexible sheet of material that includes both the wrap-around edge margin securement portion and the table top portion of the placemats 1, 16 and 26 can be made of a material such as that disclosed in U.S. Pat. No. 6,280,680, the disclosure of which relating to the components and composition of the material are incorporated herein by reference. The material is preferably environmentally degradable including by biological processes. That is, the material will at least break down into small pieces upon extended exposure to the elements. Preferably, the material of the various place mats include at least one inorganic mineral powder in the range of between about 50% and about 95% by weight of the place mat and a thermoplastic polymer present in the range of between about 50% and about 5% by weight of the place mat. Other materials may also be included. The place mats 1, 16 and 26 have opposite first and second main surfaces with the wrap-around portion adjacent to or including an edge margin portion of the sheet. There is at least one attachment member such as an adhesive strip 6 that is preferably a strip of pressure sensitive adhesive applied to the back surface of the place mat or attachment member 32 adapted to releasably secure the place mat to a supporting member such as a table top 10. Preferably, there are a plurality of such attachment members 6 or 32 each positioned adjacent a respective edge portion at the periphery of the sheet forming the place mat. The flexible sheet preferably has a thickness in the range of between about 0.001 inch and about 0.035 inch. Preferably, the material comprising at least the table top portion of the place mats 1, 16, 26 is at least water resistant and preferably waterproof, i.e., is able to at least withstand penetration of an appreciable quantity of water therethrough for at least a period of time needed to effect clean up. The degree of water resistance will depend on the amount of thermoplastic polymer to inorganic mineral powder.

Preferably, the inorganic mineral powder is at least a majority by weight CaCO₃ (calcium carbonate). Preferably, the thermoplastic polymer is at least a majority by weight polyethylene and can include one or more of low density polyethylene, medium density polyethylene and high density polyethylene. The exposed surface of the place mat is provided with a texture and the material is such that a person or child can write or color directly onto the place mat surface with markers such as crayons or other writing instruments. The present composition of the sheet material as described above greatly increases the usefulness of the present place mats and provides for interactive place mats which engage children and encourage creativity. The present place mat is an attention-grabbing device which can keep a child occupied by writing or coloring directly onto the place mat. The present place mat composition is also disposable and will break down into small pieces after several months of exposure to the elements such as by sunlight, moisture and/or biological activity, and it is at least water resistant and preferably waterproof.

Still further, it is recognized that certain embodiments of the present place mat may be adapted to protect the edge surfaces of various objects such as delicate/antique table tops or picture frames in transit and, with a pressure sensitive material or layer combination, the present devices could be used to show or indicate where the edge of an object was impacted while being transported. This could be most useful for objects like antique wood table tops where internal stresses created in transit cannot be visually ascertained.

It is also recognized and anticipated that certain embodiments of the present place mat such as a place mat made from the environmentally degradable material described herein may be used as a conventional place mat and that the edge margin wrap-around portion may be positioned in a horizontal orientation on a supporting surface such as the table top 10. Other uses and applications will become apparent to those skilled in the art.

Thus, there has been shown and described several embodiments of a novel wrap-around place mat which is adaptable for securely covering a table top as well as the edge and a portion of the underside of a table. Many changes, modifications, variations and other uses and applications of the present invention will, however, become apparent to those skilled in the art after considering this specification and the accompanying drawings. All such changes, modifications, variations and other uses and applications which do not depart from the spirit and scope of the present invention are deemed to be covered by the present invention which is limited by the claims which follow.

1. A place mat for use on a supporting member having an exposed surface, the place mat comprising:
a flexible sheet of a polymer based material, the material including between about 50% and about 95% by weight inorganic mineral powder and between about 50% and about 5% by weight thermoplastic polymer, said sheet having opposite first and second main surfaces, said sheet having a table top portion and an edge margin wrap-around portion, said wrap-around portion being adapted for wrapping around a portion of a supporting member and the table top portion being adapted to engage the surface; and
at least one attachment member secured to the sheet and adapted to releasably secure the sheet to the supporting member for use.

2. The place mat of claim 1 wherein the wrap-around portion and the table top portion being integrally formed.

3. The place mat of claim 1 wherein the table top portion being adapted to be marked on with a crayon on said first main surface.

4. The place mat of a claim 3 including indicia displayed on at least the table top portion.

5. The place mat of claim 4 wherein the inorganic mineral powder including at least a majority by weight CaCO₃.

6. The place mat of claim 5 wherein the thermoplastic polymer including at least a majority by weight polyethylene.

7. The place mat of claim 6 wherein the sheet having thickness in the range of between about 0.001 inch and about 0.035 inch.

8. The place mat of claim 1 wherein the attachment member including at least one pressure sensitive adhesive strip on said second main surface.

9. The place mat of claim 8 including a cover strip overlying and removably secured to the pressure sensitive adhesive strip.

10. The place mat of claim 8 wherein the at least one pressure sensitive strip extending around a substantial portion of the sheet adjacent the perimeter thereof.

11. The place mat of claim 1 wherein the inorganic mineral powder including at least a majority by weight CaCO₃.

12. The place mat of claim 11 wherein the thermoplastic polymer including at least a majority by weight polyethylene.

13. The place mat of claim 1 wherein the at least one attachment member including at least one clip member associated with the wrap-around portion.

14. A place mat for use on a supporting member having an exposed surface, the place mat comprising:
a flexible sheet of polymer based material, the material including between about 50% and about 95% by weight inorganic mineral powder and between about 50% and about 5% by weight thermoplastic polymer, said sheet having opposite first and second main surfaces, said sheet having a table top portion and an edge margin portion, at least the table top portion being adapted to engage the surface; and
at least one attachment member secured to the sheet and adapted to releasably secure the sheet to the supporting member for use.

15. The place mat of claim 14 wherein the edge margin portion being adapted for wrapping around a portion of a supporting member.

16. The place mat of claim 14 wherein at least the table top portion being at least water resistant.

17. The place mat of claim 14 wherein the table portion and edge margin portion being environmentally degradable.
